(19) United States
(12) Patent Application Publication
(10) Pub. No.: US 2017/0157819 A1
(43) Pub. Date: Jun. 8, 2017

(54) Method for Producing an Injection-Molded Component with an Inlay Made of an Organo-Sheet, Device for Carrying Out the Method, and Injection-Molded Component Produced According to the Method

(71) Applicant: Bayerische Motoren Werke Aktiengesellschaft, Muenchen (DE)

(72) Inventors: Manuel SCHWARZ, Landshut (DE); Oleg KONRAD, Ergolding (DE)

(21) Appl. No.: 15/434,160

(22) Filed: Feb. 16, 2017

Related U.S. Application Data
(63) Continuation of application No. PCT/EP2015/075502, filed on Nov. 3, 2015.

(30) Foreign Application Priority Data
Nov. 26, 2014 (DE) 10 2014 224 125.1

(51) Int. Cl. B29C 45/14

(52) U.S. Cl. CPC B29C 45/14786; B29C 45/14016; B29C 45/1418; B29C 2045/14286; B29K 2105/0872

(57) ABSTRACT

A method is provided for producing an injection-molded component with an inlay made of an organo sheet, including the following steps: providing a not yet consolidated endless organo sheet wound on a roll; pulling away a leading section of the endless organo sheet from the roll and introducing the section into a heating unit; heating the section to a temperature above the molding temperature; introducing the heated section into an opened injection mold, without separating the heated section from the endless organo sheet, such that a further section of the endless organo sheet is automatically drawn from the roll and introduced into the heating unit; closing the injection mold and simultaneously severing the heated section from the endless organo sheet; and producing the injection-molded component by molding the severed section and then insert molding or overmolding of the molded section.

### CROSS REFERENCE TO RELATED APPLICATIONS

This application is a continuation of PCT International Application No. PCT/EP2015/075502, filed Nov. 3, 2015, which claims priority under 35 U.S.C. §119 from German Patent Application No. 10 2014 224 125.1, filed Nov. 26, 2014, the entire disclosures of which are herein expressly incorporated by reference.

### BACKGROUND AND SUMMARY OF THE INVENTION

The invention relates to a method for producing an injection-molded component with an inlay consisting of an organo sheet, to a device for carrying out the method and to an injection-molded component produced by the method.

Organo sheets are fiber composite materials which are currently used primarily in motor vehicle and aircraft construction. There is further potential in the manufacture of front ends, seats, carriers and pedals.

Organo sheets are semifinished fiber-matrix products. They consist of a fiber fabric or a fiber crosslay which are embedded in a thermoplastic matrix. The advantages of a thermoplastic matrix reside in the hot formability of the semifinished products and the shorter process times, resulting therefrom, compared with conventional thermosetting fiber composite materials. This is of great advantage particularly in the automotive industry with its short process times. Frequently used fiber materials are glass, aramid and carbon. In fabrics and crosslays, the fibers can also extend at right angles to one another, such that the mechanical properties of organo sheets, such as rigidity, strength and thermal expansion, can be defined better than in their metal precursors. In contrast to metal sheets, the tensile and compressive behavior and other mechanical and thermal properties are not isotropic.

Consolidated semifinished organo sheet products are known, which are first of all formed into inlay parts in a separate step, are subsequently laid in an injection mold and then overmolded.

Disadvantages of consolidated semifinished organo sheet products are in particular the high costs for the semifinished products, the poor energy balance (heating twice to three times for consolidation, forming and heating for overmolding required), the complicated handling devices in the case of a large number of or large organo sheets, the necessary trimming of the organo sheet or component trimmings and the necessary higher manufacturing tolerances in consolidated organo sheet inlay parts, in order to prevent damage to tools.

Not yet consolidated organo sheets are also known, which are available as endless products on a roll.

Therefore, it is an object of the present invention to provide a method, a device and a component which avoids, or at least reduces, the disadvantages of the prior art.

This and other objects are achieved by a method for producing an injection-molded component with an inlay made of an organo sheet. The method has the following steps of:
providing a not yet consolidated endless organo sheet wound on a roll,
drawing a front portion of the endless organo sheet from the roll and introducing this portion into a heating unit,
heating the portion to a temperature above the forming temperature,
introducing the heated portion into an open injection mold without separating the heated portion from the endless organo sheet, such that a further portion of the endless organo sheet is automatically drawn from the roll and introduced into the heating unit,
closing the injection mold and simultaneously severing the heated portion from the endless organo sheet,
producing the injection-molded component by forming the severed portion and subsequently overmolding the formed portion.

With the aid of the method according to the invention, the high costs for semifinished products can be reduced, since unconsolidated material is used. The energy balance is improved since heating for consolidating, forming and the injection-molding process is necessary only once. The complicated handling devices in the case of a large number of, or large, organo sheets and the necessary higher manufacturing tolerances for consolidated organo sheet inlay parts can be eliminated.

According to a preferred development, the heated portion is severed from the endless organo sheet prior to or during the introduction into an open injection mold.

According to an advantageous development, the heated portion is drawn further into the injection mold by the forming operation, such that the cut edge is no longer located in the region of the component edge of the finished injection-molded component.

According to a preferred configuration, the severed portion is formed by use of an advancing slide which moves into the injection mold for forming and leaves the injection mold again after the forming process has been completed, in order to form a cavity for the injection-molding process in the injection mold.

The object according to the invention is also achieved by a device for producing an injection-molded component with an inlay made of an organo sheet. The device includes:
a receptacle for a roll on which a not yet consolidated endless organo sheet is wound,
a heating unit,
a gripper for drawing a front portion of the endless organo sheet from the roll and for introducing it into the heating unit,
an injection mold,
a clamping frame for introducing the heated portion into the injection mold, and
a cutting unit which is arranged between the heating unit and the injection mold.

According to an advantageous development, in order to form the severed portion of the endless organo sheet, an advancing slide is provided, which is extendable and retractable with respect to the injection mold.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a step in an exemplary method according to the invention.

FIG. 2 illustrates another step in the exemplary method according to the invention.

FIG. 3 illustrates another step in the exemplary method according to the invention.

FIG. 4 illustrates another step in the exemplary method according to the invention.

FIG. 5 illustrates another step in the exemplary method according to the invention.

FIG. 6 illustrates another step in the exemplary method according to the invention.

### DETAILED DESCRIPTION OF THE DRAWINGS

FIG. 1 shows the starting situation of a method for producing an injection-molded component 1 with an inlay made of an organo sheet 2, wherein, in the exemplary embodiment described, the injection-molded component 1 is provided with two inlays made of organo sheet. The inlays are part of a not yet consolidated endless organo sheet which is wound on a roll 3 and is provided in front of the actual injection mold 4.

Arranged between the injection mold 4 and the roll 3 is a heating station 5.

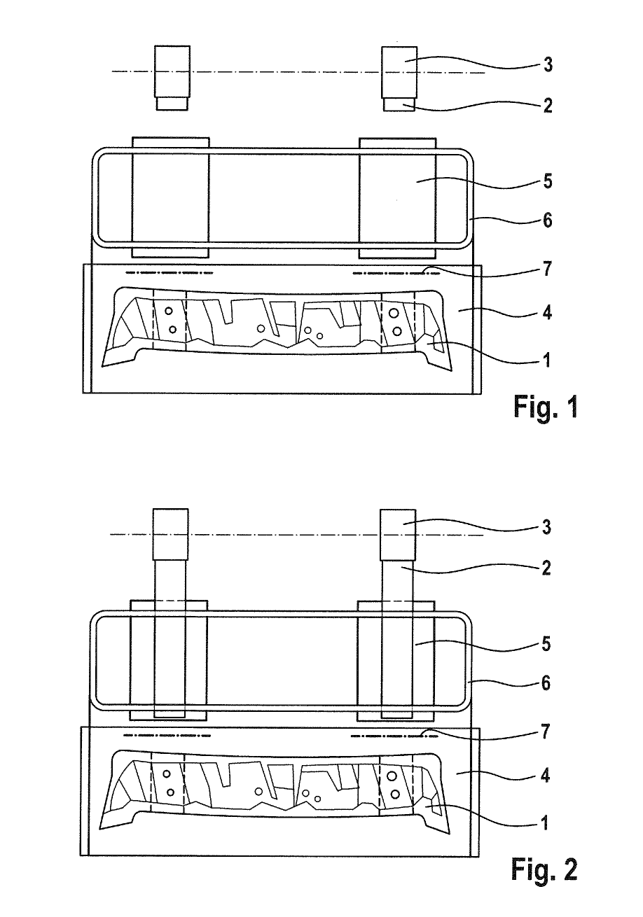

In a first method act, by use of a gripper (not illustrated), a front portion (section) of the endless organo sheet is drawn from the roll 3 and introduced into the heating unit 5. This is shown in FIG. 2.

In the heating unit 5, that portion of the organo sheet 2 that is located in the heating unit 5 is heated to a temperature which is above the forming temperature of the organo sheet 2.

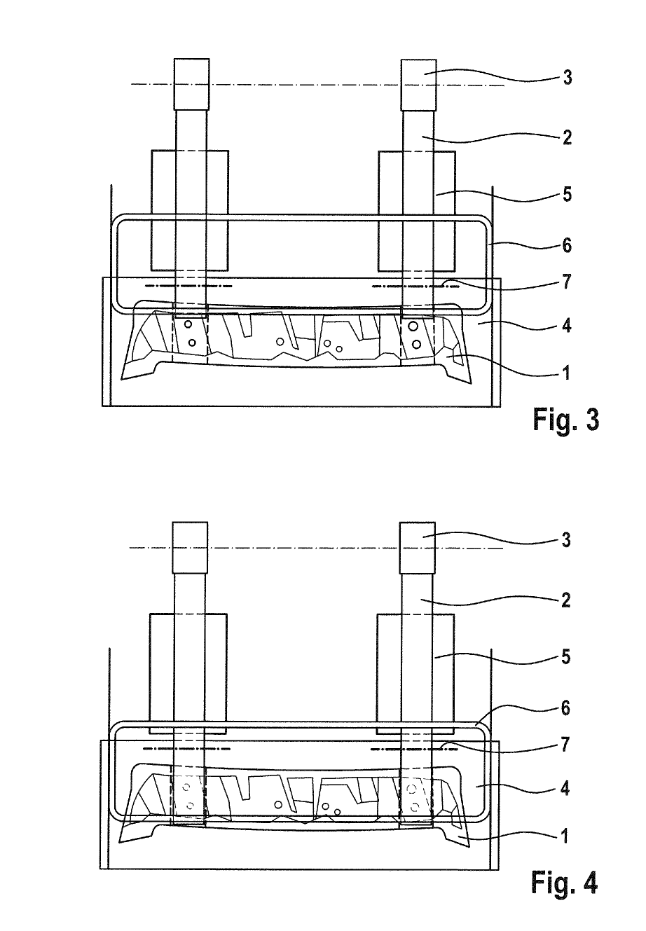

Following completion of the heating phase, that portion of the organo sheet 2 that is located in the heating unit 5 is taken by a clamping frame 6 and transported in the direction of the injection mold 4, which is open at this time. In this case, that portion of the organo sheet 2 that is located in the heating unit 5 is still connected to the endless organo sheet located on the roll 3. As a result, during the transport of the portion located in the heating unit 5, a further portion of the endless organo sheet is automatically drawn from the roll 3 and introduced into the heating unit 5. This is shown in FIGS. 3 to 5.

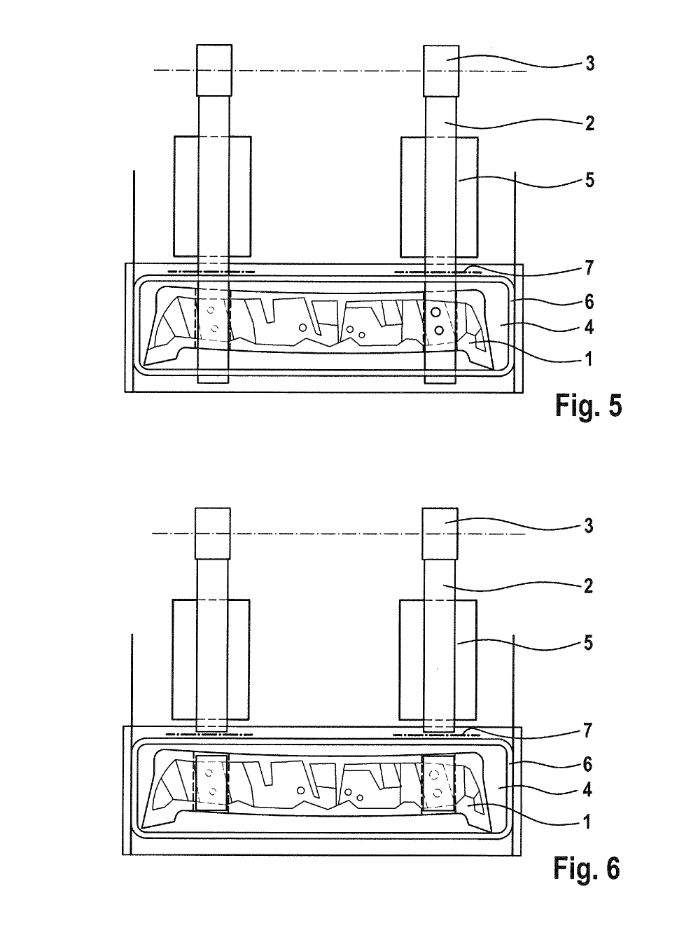

When the state shown in FIG. 5, in which the inlay 2 is located completely in the injection mold 4, has been reached, the injection mold 4 is closed. At the same time, a cutting unit 7 arranged between the injection mold 4 and the heating unit 5 is actuated. The cutting unit 7 severs that portion of the organo sheet 2 that is located in the injection mold 4 from the endless organo sheet. This is shown in FIG. 6. Alternatively, the heated portion can be severed from the endless organo sheet prior to or during the introduction into an open injection mold.

Subsequently, first of all that portion of the organo sheet 2 that is located in the injection-molded component 1 is formed into the inlay or consolidated, and subsequently, the inlay is overmolded to produce the injection-molded component 1.

After the injection mold 4 has been opened and the finished injection-molded component 1 has been removed, the described production process can start again from the beginning, by an already heated portion being drawn from the heating station 5 into the injection mold 4.

In order that the cutting edge of the organo sheet 2 is no longer located in the region of the component edge of the finished injection-molded component 1, the heated portion is drawn further into the injection mold 4 during the forming operation, as can be seen in FIG. 6.

The forming of that portion of the organo sheet 2 that is located in the injection mold 4 into an inlay takes place by use of an advancing slide (not illustrated) which moves into the injection mold 4 for forming and leaves the injection mold 4 again after the forming process has been completed, in order to form a cavity for the injection-molding process in the injection mold 4.

### LIST OF REFERENCE SIGNS

1 Injection-molded component
2 Organo sheet
3 Roll
4 Injection mold
5 Heating unit
6 Clamping frame
7 Cutting unit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing an injection-molded component with an inlay made of an organo sheet, the method comprising the acts of:
providing a not yet consolidated endless organo sheet wound on a roll;
drawing a front portion of the endless organo sheet from the roll and introducing the front portion into a heating unit;
heating the front portion to a temperature above a forming temperature,
introducing the heated portion into an open injection mold without separating the heated portion from the endless organo sheet so that a further portion of the endless organo sheet is automatically drawn from the roll and introduced into the heating unit;
closing the injection mold and severing the heated portion from the endless organo sheet; and
producing the injection-molded component by forming the severed portion and subsequently overmolding the formed severed portion.

2. The method according to claim 1, wherein
the heated portion is severed from the endless organo sheet prior to or during the introduction into the open injection mold.

3. The method according claim 1, wherein
the heated portion is drawn further into the injection mold by the forming operation, such that a cut edge is no longer located in a region of a component edge of a finished injection-molded component.

4. The method according to claim 2, wherein
the severed portion is formed by use of an advancing slide which moves into the injection mold for forming and leaves the injection mold again after the forming has been completed, in order to form a cavity for the injection-molding in the injection mold.

5. The method according to claim 3, wherein
the severed portion is formed by use of an advancing slide which moves into the injection mold for forming and leaves the injection mold again after the forming has been completed, in order to form a cavity for the injection-molding in the injection mold.

6. The method according to claim 1, wherein the severing of the heated portion of the endless organo sheet is performed simultaneously with the closing of the injection mold.

7. A device for producing an injection-molded component with an inlay made of an organo sheet, comprising:
a receptacle for a roll on which a not yet consolidated endless organo sheet is wound;
a heating unit;
a gripper for drawing a front portion of the endless organo sheet from the roll and for introducing the front portion into the heating unit;
an injection mold;
a clamping frame for introducing the heated portion into the injection mold; and
a cutting unit which is arranged between the heating unit and the injection mold.

8. The device according to claim 7, wherein, in order to form the severed portion of the endless organo sheet, an advancing slide is provided, which is extendable and retractable with respect to the injection mold.

9. An injection-molded component with an inlay made of an organo sheet, produced by the method according to claim 1.
